(19) United States
(12) Patent Application Publication
(10) Pub. No.: US 2013/0170652 A1
(43) Pub. Date: Jul. 4, 2013

(54) FRONT WAVE FIELD SYNTHESIS (WFS) SYSTEM AND METHOD FOR PROVIDING SURROUND SOUND USING 7.1 CHANNEL CODEC

(71) Applicant: ELECTRONICS AND TELECOMMUNICATIONS R, Daejeon (KR)

(72) Inventors: Jae Hyoun YOO, Daejeon (KR); Jeong Il SEO, Daejeon (KR); Tae Jin LEE, Daejeon (KR); Keun Woo CHOI, Seoul (KR); Kyeong Ok KANG, Daejeon (KR)

(73) Assignee: ELECTRONICS AND TELECOMMUNICATIONS RESEARCH INSTITUTE, Daejeon (KR)

(21) Appl. No.: 13/651,708

(22) Filed: Oct. 15, 2012

(30) Foreign Application Priority Data
Dec. 30, 2011 (KR) 10-2011-0147537

(51) Int. Cl. H04R 5/00

(52) U.S. Cl. 381/22

(57) ABSTRACT

Provided is a system and method for front wave field synthesis (WFS) to provide a surround sound with a reduced number of loudspeakers. An apparatus for encoding a front WFS signal in the front WFS system may include a content receiving unit to receive WFS content including the first channels corresponding to a front array speaker and the second channels corresponding to a rear surround sound speaker, and an encoding unit to encode the first channels and the second channels using a multichannel encoder corresponding to the number of the channels included in the WFS content.

### CROSS-REFERENCE TO RELATED APPLICATION

This application claims the priority benefit of Korean Patent Application No. 10-2011-0147537, filed on Dec. 30, 2011, in the Korean Intellectual Property Office, the disclosure of which is incorporated herein by reference.

### BACKGROUND

1. Field of the Invention

Exemplary embodiments relate to a system and method for reproducing a wave field synthesis (WFS) signal, and more particularly, to a WFS system and method for reproducing a WFS signal using a front array speaker including six loudspeakers and a rear surround sound speaker including two discrete loudspeakers to provide a surround sound with a reduced number of loudspeakers.

2. Description of the Related Art

A wave field synthesis (WFS) technique provides a surround sound to a listener in an auditory space by synthesizing wavefronts of sound sources to be reproduced.

A conventional WFS technique is optimized for an acoustic environment surrounding a listener in 360 degrees, for example, a large-scale theater and the like. However, dissimilar to a large-scale theater, most of private homes have an insufficient space to place a loudspeaker array at the front, left, right, and rear sides. Accordingly, development has been conducted to reduce the number of loudspeakers.

For example, a sound bar with a horizontally long front stereo speaker has been recently suggested to simplify installation. The sound bar is advantageous in an aspect of interior design but has a limitation in providing a surround sound.

Accordingly, a need for an environment for surround sound reproduction by WFS with a reduced number of loudspeakers is present.

Also, WFS content includes an audio object signal and sound image localization information. However, when a sound reproduction environment is fixed to a predetermined environment, a need to transmit both audio object signal and sound image localization information is absent. Accordingly, a method of transmitting a WFS signal rendered to be optimized for a predetermined environment is required to reduce an amount of information of the signal.

### SUMMARY

An aspect of the present invention provides a system and method for providing a surround sound with a reduced number of loudspeakers.

Another aspect of the present invention also provides a system and method for reproducing a wave field synthesis (WFS) signal absent transmission of sound image localization information.

According to an aspect of the present invention, there is provided an apparatus for encoding a front WFS signal, the apparatus including a content receiving unit to receive WFS content including the first channels corresponding to a front array speaker and the second channels corresponding to a rear surround sound speaker, and an encoding unit to encode the the first channels and the second channels using a multichannel encoder corresponding to the number of the channels included in the WFS content.

According to another aspect of the present invention, there is provided an apparatus for decoding a front WFS signal, the apparatus including a decoding unit to decode multiple channels in a WFS signal using a multichannel decoder, a channel classifying unit to classify the decoded channels into the first channels corresponding to a front array speaker and the second channels corresponding to a rear surround sound speaker, and a channel transmitting unit to transmit each of the channels to the speaker corresponding to the channel based on the classified result.

According to still another aspect of the present invention, there is provided a front WFS system including an encoding apparatus to encode six the first channels corresponding to a front array speaker including six loudspeakers and two the second channels corresponding to a rear surround sound speaker including two discrete loudspeakers, using a 7.1 channel encoder, and a decoding apparatus to decode the first channels and the second channels in a received signal using a 7.1 channel decoder and to transmit each of the channels to the speaker corresponding to the channel.

According to yet another aspect of the present invention, there is provided a method for encoding a front WFS signal, the method including receiving WFS content including the first channels corresponding to a front array speaker and the second channels corresponding to a rear surround sound speaker, and encoding the first channels and the second channels using a multichannel encoder corresponding to the number of the channels included in the WFS content.

According to further another aspect of the present invention, there is provided a method for decoding a front WFS signal, the method including decoding multiple channels in a WFS signal using a multichannel decoder, classifying the decoded channels into the first channels corresponding to a front array speaker and the second channels corresponding to a rear surround sound speaker, and transmitting each of the channels to the speaker corresponding to the channel based on the classified result.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating a front wave field synthesis (WFS) system according to an embodiment of the present invention;

FIG. 2 is a diagram illustrating an example of a sound reproduction environment for a front WFS system according to an embodiment of the present invention;

FIG. 3 is a diagram illustrating encoding of a front WFS signal in an apparatus for encoding the front WFS signal according to an embodiment of the present invention;

FIG. 4 is a diagram illustrating decoding of a front WFS signal in an apparatus for decoding the front WFS signal according to an embodiment of the present invention;

FIG. 5 is a flowchart illustrating a method of encoding a front WFS signal according to an embodiment of the present invention; and

FIG. 6 is a flowchart illustrating a method of decoding a front WFS signal according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

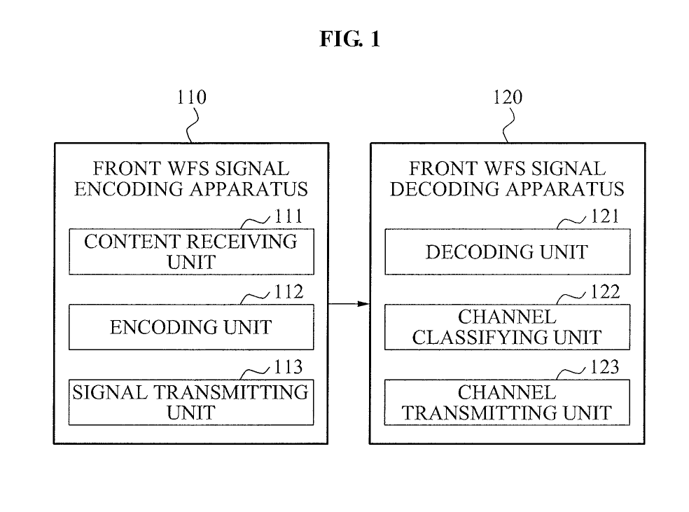

FIG. 1 is a block diagram illustrating a front wave field synthesis (WFS) system according to an embodiment of the present invention.

Referring to FIG. 1, the front WFS system may include an apparatus 110 for encoding a front WFS signal and an apparatus 120 for decoding the front WFS signal.

The encoding apparatus 110 may include a content receiving unit 111, an encoding unit 112, and a signal transmitting unit 113.

The content receiving unit 111 may receive WFS content including the first channels corresponding to a front array speaker and the second channels corresponding to a rear surround sound speaker.

In this instance, the WFS content may include six the first channels corresponding to the front array speaker including six loudspeakers and two the second channels corresponding to the rear surround sound speaker including two discrete loudspeakers.

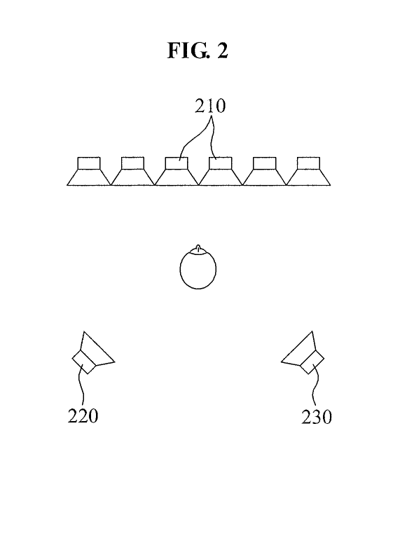

A description of an environment for reproducing the WFS content received by the content receiving unit 111 is provided in further detail with reference to FIG. 2.

The encoding unit 112 may encode the first channels and the second channels using a multichannel encoder corresponding to the number of the channels included in the WFS content received by the content receiving unit 111, to generate a front WFS signal.

The encoding unit 112 may encode the first channels and the second channels by inputting the first channels and the second channels in the multichannel encoder based on a condition for identifying the first channel and the second channel. The condition for identifying the first channel and the second channel may correspond to a channel input order in the multichannel encoder.

For example, the encoding unit 112 may encode the six the first channels and the two the second channels included in the WFS content, using an eight-channel 7.1 encoder. In this instance, when the condition for identifying the first channel and the second channel is such that signals of 1^{st} through 6^{th} channels correspond to signals of the front array speaker from leftmost to rightmost in a sequential order, and signals of 7^{th} and 8^{th} channels correspond to signals of left and right channels of the rear surround sound speaker respectively, the encoding unit 112 may encode the first channels and the second channels by inputting the first channels in first through sixth channels of the 7.1 channel encoder and the second channels in seventh and eighth channels of the 7.1 channel encoder, respectively.

The signal transmitting unit 113 may transmit the front WFS signal generated by the encoding unit 112 to the decoding apparatus 120.

The decoding apparatus 120 may include a decoding unit 121, a channel classifying unit 122, and a channel transmitting unit 123.

The decoding unit 121 may decode multiple channels in the WFS signal received from the encoding apparatus 110, using a multichannel decoder.

For example, the decoding unit 121 may decode eight channels in the front WFS signal using a 7.1 channel decoder. In this instance, the 7.1 channel decoder may be incorporated in a 7.1 channel CODEC, along with the 7.1 channel encoder.

The channel classifying unit 122 may classify the channels decoded by the decoding unit 121 into the first channels corresponding to a front array speaker and the second channels corresponding to a rear surround sound speaker.

The channel classifying unit 122 may classify the decoded channels into the first channels and the second channels based on a condition for identifying the first channel and the second channel.

For example, when the condition for identifying the first channel and the second channel is such that signals of 1^{st} through 6^{th} channels correspond to signals of the front array speaker from leftmost to rightmost in a sequential order, and signals of 7^{th} and 8^{th} channels correspond to signals of left and right channels of the rear surround sound speaker respectively, the channel classifying unit 122 may classify the first through sixth channels among the channels outputted from the 7.1 channel decoder into the first channel, and may classify the seventh and eighth channels into the second channel.

The channel transmitting unit 123 may transmit each of the channels to the speaker corresponding to the channel based on the classified result by the channel classifying unit 122.

For example, the channel transmitting unit 123 may transmit signals of first through sixth channels classified as the first channels to the front array speaker from leftmost to rightmost in a sequential order. Also, the channel transmitting unit 123 may transmit signals of the seventh and eighth channels classified as the second channels to a left rear surround sound speaker and a right rear surround sound speaker, respectively.

Accordingly, the front WFS system according to an embodiment of the present invention may encode and transmit a WFS signal rendered to be optimized for a predetermined environment using a multichannel encoder, and during decoding, may identify a speaker corresponding to each channel based on a channel input order and may transmit the WFS signal to the corresponding speaker, to reproduce the WFS signal absent transmission of sound image localization information.

FIG. 2 is a diagram illustrating an example of a sound reproduction environment for the front WFS system according to an embodiment of the present invention.

Referring to FIG. 2, the sound reproduction environment for the WFS system according to an embodiment of the present invention may include a front array speaker 210 placed at the front side of a user, and rear left and right surround sound speakers 220 and 230 placed at the left and right sides of the user.

In this instance, the front array speaker 210 may include six loudspeakers, and the rear left and right surround sound speakers 220 and 230 may correspond to discrete loudspeakers, as shown in FIG. 2.

Although FIG. 2 shows a sound reproduction environment using eight speakers and a 7.1 channel CODEC, the present invention is not limited in this regard. For example, in a sound reproduction environment using six speakers and a 5.1 channel CODEC, the front WFS system according to an embodiment of the present invention may reproduce a WFS signal absent transmission of sound image localization information, when a condition for identifying WFS content for a sound reproduction environment and a channel corresponding to each speaker is set.

Accordingly, the present invention may provide a surround sound with a reduced number of loudspeakers by reproducing a WFS signal using a front array speaker including six loudspeakers and a rear surround sound speaker including two discrete loudspeakers.

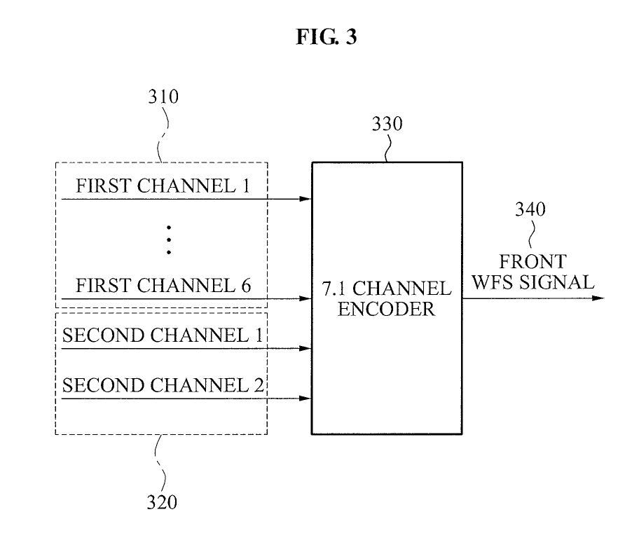

FIG. 3 is a diagram illustrating encoding of a front WFS signal in the encoding apparatus 110 according to an embodiment of the present invention.

Referring to FIG. 3, the encoding unit 112 of the encoding apparatus 110 may encode WFS content including six the first channels 310 corresponding to a front array speaker including six loudspeakers and two the second channels 320 corresponding to a rear surround sound speaker including two discrete loudspeakers, using a 7.1 channel encoder 300, to generate a front WFS signal 340.

In this instance, when the condition for identifying the first channel and the second channel is such that signals of 1^{st} through 6^{th} channels correspond to signals of the front array speaker from leftmost to rightmost in a sequential order, and signals of 7^{th} and 8^{th} channels correspond to signals of left and right channels of the rear surround sound speaker respectively, the encoding unit 112 may encode the first channels 310 and the second channels 320 by inputting the first channels 310 in first through sixth channels of the 7.1 channel encoder and the second channels 320 in seventh and eighth channels of the 7.1 channel encoder.

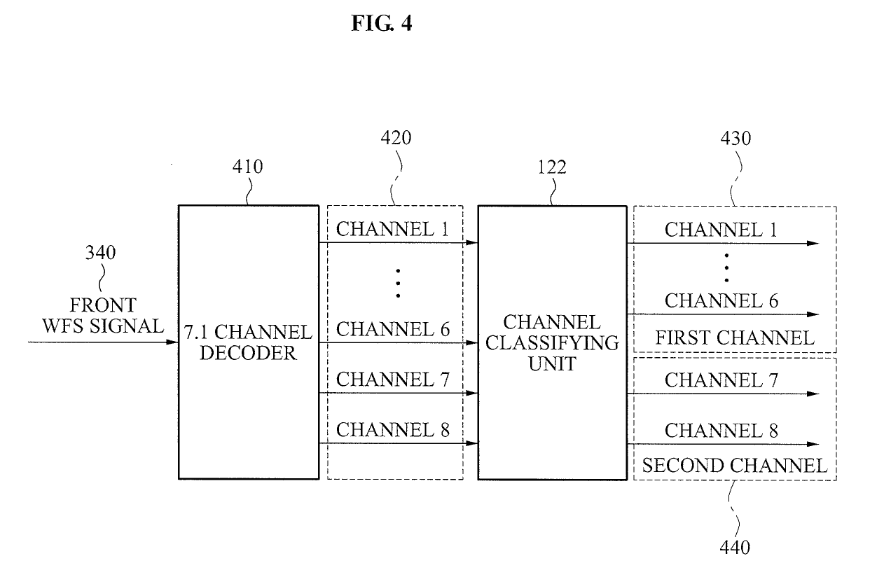

FIG. 4 is a diagram illustrating decoding of a front WFS signal in the decoding apparatus 120 according to an embodiment of the present invention.

Referring to FIG. 4, the decoding unit 121 of the decoding apparatus 120 may decode eight channels 420 in the front WFS signal 340 using a 7.1 channel decoder 410.

The channel classifying unit 122 may classify the channels 420 decoded by the decoding unit 121 into the first channels 430 corresponding to the front array speaker and the second channels 440 corresponding to the rear surround sound speaker.

For example, when the condition for identifying the first channel 430 and the second channel 440 is such that signals of 1^{st} through 6^{th} channels correspond to signals of the front array speaker from leftmost to rightmost in a sequential order, and signals of 7^{th} and 8^{th} channels correspond to signals of left and right channels of the rear surround sound speaker respectively, the channel classifying unit 122 may classify the first through sixth channels among the channels outputted from the 7.1 channel decoder 410 as the first channels 430, and may classify the seventh and eighth channels as the second channels 440.

The channel transmitting unit 123 may transmit signals of the first through sixth channels classified as the first channels 430 to the front array speaker from leftmost to rightmost in a sequential order. Also, the channel transmitting unit 123 may transmit signals of the seventh and eighth channels classified as the second channels 440 to the rear left and right surround sound speaker respectively.

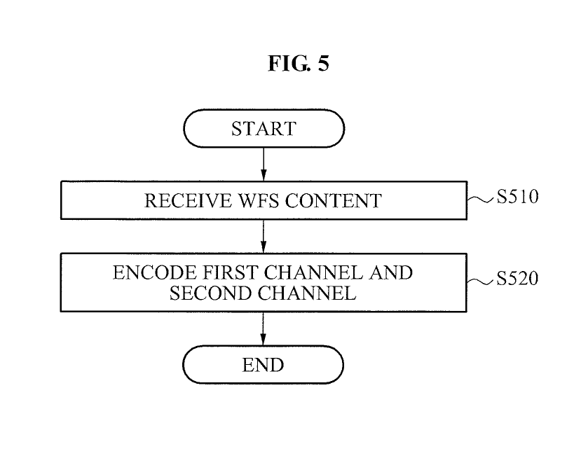

FIG. 5 is a flowchart illustrating a method of encoding a front WFS signal according to an embodiment of the present invention.

In S510, the content receiving unit 111 may receive WFS content including the first channels corresponding to a front array speaker and the second channels corresponding to a rear surround sound speaker.

In S520, the encoding unit 112 may encode the first channels and the second channels using a multichannel encoder corresponding to the number of the channels included in the WFS content received in S510, to generate a front WFS signal. In this instance, the encoding unit 112 may encode the first channels and the second channels by inputting the first channels and the second channels in the multichannel encoder based on a condition for identifying the first channel and the second channel.

In this instance, the signal transmitting unit 113 may transmit the front WFS signal generated by the encoding unit 112 to the decoding apparatus 120.

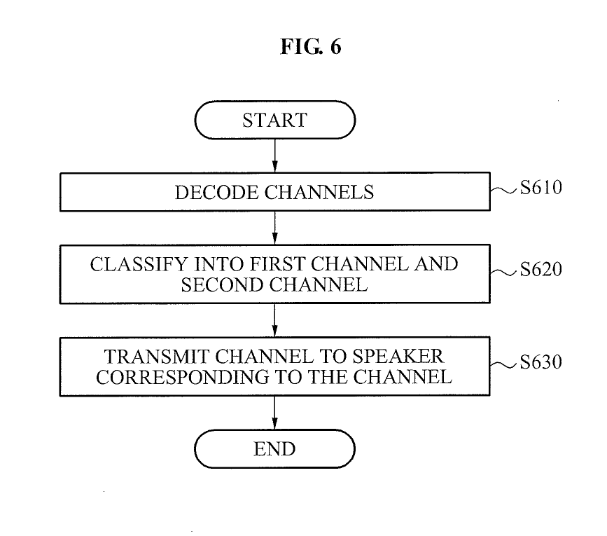

FIG. 6 is a flowchart illustrating a method of decoding the front WFS signal according to an embodiment of the present invention.

In S610, the decoding unit 121 may decode multiple channels in the front WFS signal received from the encoding apparatus 110, using a multichannel decoder.

In S620, the channel classifying unit 122 may classify the channels decoded in S610 into the first channels corresponding to a front array speaker and the second channels corresponding to a rear surround sound speaker. In this instance, the channel classifying unit 122 may classify the decoded channels into the first channels and the second channels based on a condition for identifying the first channel and the second channel.

In S630, the channel transmitting unit 123 may transmit each of the channels to the speaker corresponding to the channel classified in S620.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard discs, floppy discs, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

The present invention may provide a surround sound with a reduced number of loudspeakers by reproducing a WFS signal using a front array speaker including six loudspeakers and a rear surround sound speaker including two discrete loudspeakers.

Also, the present invention may encode and transmit a WFS signal rendered to be optimized for a predetermined environment using a multichannel encoder, and during decoding, may transmit each channel to a speaker corresponding to the channel based on a channel input order, to reproduce the WFS signal absent transmission of sound image localization information.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An apparatus for encoding a front wave field synthesis (WFS) signal, the apparatus comprising:
a content receiving unit to receive WFS content including the first channels corresponding to a front array speaker and the second channels corresponding to a rear surround sound speaker; and
an encoding unit to encode the first channels and the second channels using a multichannel encoder corresponding to the number of the channels included in the WFS content.

2. The apparatus of claim 1, wherein the encoding unit encodes the first channels and the second channels by inputting the first channels and the second channels in the multichannel encoder based on a condition for identifying the first channel and the second channel.

3. The apparatus of claim 2, wherein the condition for identifying the first channel and the second channel corresponds to a channel input order in the multichannel encoder.

4. The apparatus of claim 3, wherein the WFS content includes six the first channels corresponding to the front array speaker including six loudspeakers and two the second channels corresponding to the rear surround sound speaker including two discrete loudspeakers.

5. The apparatus of claim 4, wherein the encoding unit encodes the six the first channels and the two the second channels using a 7.1 channel encoder.

6. An apparatus for decoding a front wave field synthesis (WFS) signal, the apparatus comprising:
a decoding unit to decode multiple channels in a WFS signal using a multichannel decoder;
a channel classifying unit to classify the decoded channels into the first channels corresponding to a front array speaker and the second channels corresponding to a rear surround sound speaker; and
a channel transmitting unit to transmit each of the channels to the speaker corresponding to the channel based on the classified result.

7. The apparatus of claim 6, wherein the channel classifying unit classifies the decoded channels into the first channels and the second channels based on a condition for identifying the first channel and the second channel.

8. The apparatus of claim 7, wherein the condition for identifying the first channel and the second channel corresponds to a channel decoding order.

9. A front wave field synthesis (WFS) system comprising:
an encoding apparatus to encode six the first channels corresponding to a front array speaker including six loudspeakers and two the second channels corresponding to a rear surround sound speaker including two discrete loudspeakers, using a 7.1 channel encoder; and
a decoding apparatus to decode the first channels and the second channels in a received signal using a 7.1 channel decoder and to transmit each of the channels to the speaker corresponding to the channel.

10. A method for encoding a front wave field synthesis (WFS) signal, the method comprising:
receiving WFS content including the first channels corresponding to a front array speaker and the second channels corresponding to a rear surround sound speaker; and
encoding the first channels and the second channels using a multichannel encoder corresponding to the number of the channels included in the WFS content.

11. The method of claim 10, wherein the encoding comprises encoding the first channels and the second channels by inputting the first channels and the second channels in the multichannel encoder based on a condition for identifying the first channel and the second channel.

12. The method of claim 11, wherein the condition for identifying the first channel and the second channel corresponds to a channel input order in the multichannel encoder.

13. The method of claim 10, wherein the WFS content includes the six the first channels corresponding to the front array speaker including six loudspeakers and the two the second channels corresponding to the rear surround sound speaker including two discrete loudspeakers.

14. The method of claim 13, wherein the encoding comprises encoding the six the first channels and the two the second channels using a 7.1 channel encoder.

15. A method for decoding a front wave field synthesis (WFS) signal, the method comprising:
decoding multiple channels in a WFS signal using a multichannel decoder;
classifying the decoded channels into the first channels corresponding to a front array speaker and the second channels corresponding to a rear surround sound speaker; and
transmitting each of the channels to the speaker corresponding to the channel based on the classified result.

16. The method of claim 15, wherein the classifying comprises classifying the decoded channels into the first channels and the second channels based on a condition for identifying the first channel and the second channel.

17. The method of claim 16, wherein the condition for identifying the first channel and the second channel corresponds to a channel decoding order.
